(19) United States
(12) Patent Application Publication
(10) Pub. No.: US 2002/0046486 A1
(43) Pub. Date: Apr. 25, 2002

(54) Woody plant injection method and apparatus

(76) Inventors: Peter M. Wild, Winchester, MA (US); David E. Floyd, Marlborough, MA (US); Lewis D. Mikesell, Mesa, AZ (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 09/902,494

(22) Filed: Jul. 10, 2001

Related U.S. Application Data
(60) Provisional application No. 60/217,068, filed on Jul. 10, 2000.
(60) Provisional application No. 60/266,148, filed on Feb. 2, 2001.

(51) Int. Cl. A01G 29/00

(52) U.S. Cl. 47/57.5

(57) ABSTRACT

A method for injecting fluid into woody plant is disclosed, and apparatus therefor, for delivering disease treatments and nutritional supplements.

### RELATED APPLICATIONS

This application claims the benefit of U.S. Provisional Application No. 60/217,068, filed Jul. 10, 2000, and U.S. Provisional Application No. 60/266,148, filed Feb. 2, 2001. The entire teachings of the above applications are incorporated herein by reference.

### BACKGROUND OF THE INVENTION

Injection treatment of plants is a method of introducing an agent into a plant. The agent can be introduced into the plant by gravity or under pressure, and a wide variety of devices exist for injecting plants.

Injection treatment is useful for the treatment of disease conditions or insect infestation, such as Dutch Elm Disease, American Chestnut Blight, Woolly Adelgid, Red Palm Weevil, etc. Fungicides, insecticides, and chemicals can be administered by injection.

Nutritional supplements can also be administered by injection, to maintain, improve, or enhance the health of the plant. Such administration can also be an effective form of prevention of disease and insect attack, as many diseases and insects attack plants that are in suboptimal health or are otherwise stressed.

Many plants are quite valuable, especially in the case of slow-growing plants such as trees or woody vines (e.g., grapevines). A tree can take many years to grow to maturity, and it is therefore desirable to maintain adult trees in a healthy state, given the cost and inconvenience of removal and replacement of trees. Likewise, some woody plants, such as grapevines and fruit trees, are valuable because of their crop value, and the time required to bring a replacement plant to maturity is time during which the plant is not producing income.

In general, in administration of agents to trees, many devices require drilling a hole in the tree to allow insertion into the tree of all or a portion of the device. However, drilling a hole is injurious to the tree, and allows the entry of pathogens and insects to the interior of the tree. Most plants generally have mechanisms for “sealing off” a damaged site, but even so, such damage can stress the plant, making the plant susceptible, or even attractive, to insects and diseases.

Once an administration device is removed, the hole can be filled in with a plug or other means of filling in the hole. However, the plant has still been injured, and may become susceptible to subsequent attack by pests and diseases. In addition, diseases and pests can still enter at the join between the plug and the plant. Furthermore, leaving objects in a plant can retard or interfere with later growth of the plant.

Therefore, a need exists for an apparatus and method for treating a woody plant that overcomes the aforementioned problems.

### SUMMARY OF THE INVENTION

The present invention relates to methods for injecting fluids into plants, especially woody plants, e.g., trees and woody vines.

The invention features a method for injecting a fluid into a woody plant (e.g., a tree (e.g., a dicotyledon, a gymnosperm), a palm tree, a woody vine (e.g., grapevine)), comprising providing (1) a fluid reservoir containing a fluid, (2) a carrier gas reservoir containing a carrier gas, (3) a needle having a proximal end and a distal end, where the needle comprises (a) an inner conduit, (b) a sealed tip terminating in a point at the distal end, (c) an outer surface, and (d) at least one aperture connecting the inner conduit and the outer surface and proximate to the point at said distal end, (4) an injector connecting the fluid reservoir and the carrier gas reservoir to the proximal end of the needle, where the injector can direct at least a portion of the fluid from the fluid reservoir with at least a portion of the carrier gas from the carrier gas reservoir, through the inner conduit of the needle and out of at least one of the apertures; then inserting the needle into the woody plant, and injecting, via the injector, at least a portion of the fluid from the fluid reservoir with at least a portion of the carrier gas from the carrier gas reservoir, through the inner conduit of the needle and out of at least one of the apertures and into the woody plant; thereby injecting the fluid into the woody plant. The method can be repeated one or more times on the same woody plant. The fluid can be a treatment for a disease condition, or an insect infestation. The fluid can be a nutrient. The fluid can be aqueous, oleaginous, a suspension, or a combination thereof. The needle can be inserted into expansion tissue. The needle can include two apertures. One or more apertures connecting the inner conduit and the outer surface can be at a forward angle relative to the longitudinal axis of the needle, e.g., the one or more apertures can be at an angle in the range of about 50° and about 130° relative to the longitudinal axis of the needle, or in the range of about 60° and about 120° relative to the longitudinal axis of the needle, or about 65° relative to the longitudinal axis of the needle. At least a portion of the outer surface of the needle between the point and one of the apertures can include a taper. The needle can have a first portion from the proximal end to a shoulder point, where the outer surface of the first portion can have a first taper, and the needle can also have a second portion from the shoulder point to the distal end, where the second portion can have a second taper which is substantially greater than the first taper. The second taper can have an angle in the range of about 10° and about 50° relative to the longitudinal axis of the needle, or in the range of about 20° and about 40° relative to the longitudinal axis of the needle, or about 30° relative to the longitudinal axis of the needle. At least one of the apertures can be located between the shoulder point and the proximal end.

The invention also features a method for injecting a medicament (e.g., a fertilizer, a pesticide, a fungicide, a growth regulator and a hormone) into a plant, comprising providing a medicament for a plant, mixing the medicament with a compressed carrier gas (e.g., carbon dioxide, air, nitrogen), and directing the medicament and compressed carrier gas through the surface of a plant to inject the medicament into the plant. As a propellant, air is frequently divided into three basic categories: (1) low pressure air (“LPA”), which is generally less than 1,207 kiloPascals (175 pounds per square inch), medium pressure air (“MPA”), which is generally 1,207 2,586 kiloPascals (175-375 pounds per square inch), and high pressure air (“HPA”), which is generally greater than 2,586 kilopascals (375 pounds per square inch).

The present invention also relates to an apparatus for injecting woody plants.

In another aspect, the invention features an apparatus for injecting a fluid into a woody plant (e.g., a tree (e.g., a dicotyledon, a gymnosperm), a palm tree, a woody vine (e.g., grapevine)), comprising, (a) a fluid reservoir containing a fluid, (b) a carrier gas reservoir containing a carrier gas, (c) a needle having a proximal end and a distal end, comprising (i) an inner conduit, (ii) a sealed tip terminating in a point at the distal end, (iii) an outer surface, and (iv) at least one aperture connecting the inner conduit and the outer surface and proximate to the point at said distal end and (c) an injector connecting the fluid reservoir and the carrier gas reservoir to the proximal end of the needle, wherein the injector can direct at least a portion of the fluid from the fluid reservoir with at least a portion of the carrier gas from the carrier gas reservoir, through the inner conduit of the needle and out of at least one of the apertures. The fluid can be a treatment for a disease condition, or an insect infestation. The fluid can be a nutrient. The fluid can be aqueous, oleaginous, a suspension, or a combination thereof. The needle can include two apertures. One or more apertures connecting the inner conduit and the outer surface can be at a forward angle relative to the longitudinal axis of the needle, e.g., the one or more apertures can be at an angle in the range of about 50° and about 130° relative to the longitudinal axis of the needle, or in the range of about 60° and about 120° relative to the longitudinal axis of the needle, or about 65° relative to the longitudinal axis of the needle. At least a portion of the outer surface of the needle between the point and one of the apertures can include a taper. The needle can have a first portion from the proximal end to a shoulder point, where the outer surface of the first portion can have a first taper, and the needle can also have a second portion from the shoulder point to the distal end, where the second portion can have a second taper which is substantially greater than the first taper. The second taper can have an angle in the range of about 10° and about 50° relative to the longitudinal axis of the needle, or in the range of about 20° and about 40° relative to the longitudinal axis of the needle, or about 30° relative to the longitudinal axis of the needle. At least one of the apertures can be located between the shoulder point and the proximal end.

### BRIEF DESCRIPTION OF THE DRAWINGS

FIG. 1 is a diagram showing a cross-section of a dicotyledonous tree, including the bark (“A”), the phloem (“B”), the cambium (“C”) and the xylem (“D”).

FIG. 2 is a diagram showing a cross-section of a palm stem, with two vascular bundles. Each vascular bundle is composed of xylem and phloem, with the small phloem cells in the center of each vascular bundle, surrounded by the xylem cells.

FIG. 3 is a side elevational view of a needle of an embodiment of the invention.

FIG. 4 is a side elevational view of the ti of a needle of an embodiment of the invention.

FIG. 5 is a diagram showing a cross-sectional view of an inoculator of an embodiment of the invention.

FIG. 6 is a diagram showing a cross-sectional view of an inoculator of another embodiment of the invention.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. All parts and percentages are by weight unless otherwise indicated.

### DETAILED DESCRIPTION OF THE INVENTION

A description of preferred embodiments of the invention follows.

In one embodiment, the invention features a method for injecting fluid medicaments into plants, especially woody plants, e.g., trees, shrubs, vines.

Medicaments are agents that can promote recovery from injury or ailment in plants, and can include fertilizers, pesticides, fungicides, growth regulators and hormones. The medicaments can be inserted into the phloem area or functional xylem area of a plant in small amounts between the cork cambium and cambium areas. In one embodiment, the fluid medicaments are inserted into the vascular cambium of the plant. In another embodiment, the fluid is placed within the stem of the plant.

Once placed, the product can travel down the phloem into the root zone, and/or up the xylem throughout the tree to accomplish the desired task. With this method, many insect pests that feed on plants can be controlled, and diseases can be controlled. Mineral deficiencies can be balanced with fertilizers, and growth rates of plants can be controlled with fertilizers or growth hormones.

The method of the invention includes the injection of medicaments into plants. The injection includes employing an injection needle. The needle can be about 1.5 cm (0.6 inches) to about 5.0 cm (2.0 inches) long, with at least one small aperture at the distal end of the needle. In one embodiment, the needle is about 2.5 cm (1.0 inch) to about 3.8 cm (1.5 inches) long, with at least one small aperture at the distal end of the needle. The purpose of this needle is to inject the product into larger trees with deeply fissured bark, e.g. the needle can be used with deciduous and evergreen trees and shrubs. In another embodiment, the needle is approximately 0.96 cm (0.375 inches) long, and the aperture(s) are 0.00032 cm (0.000125 inches). This needle can be used for smooth barked evergreen or deciduous trees and shrubs. The needle can be made of hardened and/or is formed of stainless steel or other similar material. In another embodiment, the needle is 4 cm (1.75 inches) long with two apertures of 0.081 cm (0.032 inches). In another embodiment, the needle is 2 cm (0.75 inches) long with two apertures of 0.038 cm (0.015 inches).

In one embodiment, the method is used to inject fluids into a woody plant. “Woody plant”, as used herein, refers to plants having stiff stems with a protective outer coating (bark). Examples of woody plants that can be injected by the methods and apparatus of the invention include, but are not limited to, trees, palms, shrubs and woody vines (e.g., grapes, wisteria, trumpet vine, etc.).

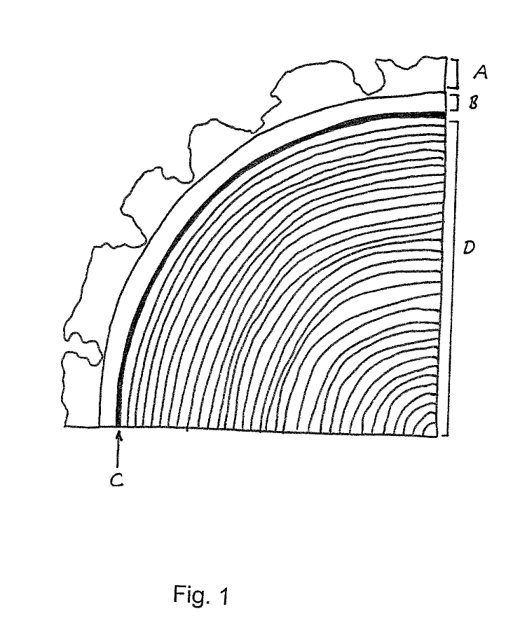

In dicotyledonous plants, a diagram of which is shown in FIG. 1, and gymnosperms, the xylem is that interior portion of the plant stem which transports water upward from the roots. The phloem lies on the outer portion of the stem, and transports the products of photosynthesis from the leaves to the remainder of the plant. The vascular cambium lies between the xylem and the phloem. The cambium is a very thin layer of cells which has the function of producing vascular tissue: both the xylem (towards the interior of the stem) and the phloem (towards the exterior of the stem).

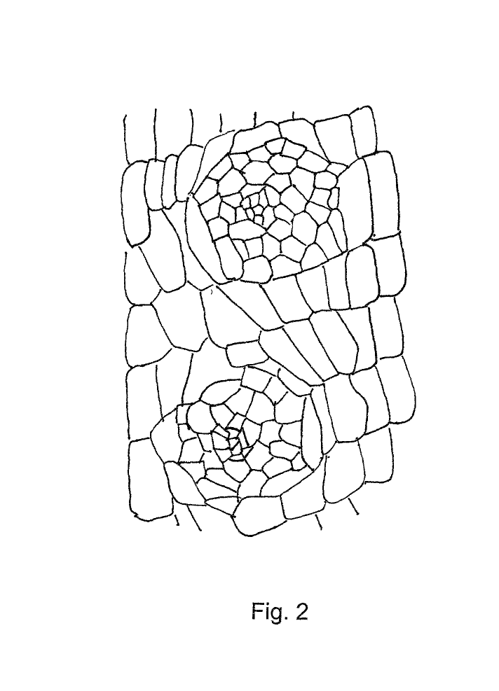

The monocotyledonous plants, often referred to as the “grass family”, have diffuse secondary growth, which does not involve a ringlike vascular cambium. Instead, cells in the stem divide and enlarge, increasing the girth of the stem. Vascular bundles (composed of phloem and xylem) form within the stem. Most of the palm tree stem, for instance, is composed of such tissue with bundles of vascular tissue (phloem and xylem) scattered randomly throughout, as shown in the diagram in FIG. 2. Cordyline is a also woody monocot, but the vascular bundles are produced towards the inside of the stem.

In the case of woody plants that possess a ringlike cambium layer, e.g., woody dicotyledonous plants (e.g., hardwoods) and woody gymnosperms (e.g., conifers), the fluid is injected into the cambium layer. In one embodiment, the operator selects points on the trunk (stem) of the plant to be injected. In the case of plants with a thick protective outer later (bark), the points into which injections are to be made corresponding to fissures (cracks) in the bark, in which expansion zone tissue can be seen. “Expansion zone tissue” refers to a layer of tissue beneath the bark, where the plant is actively expanding in girth. Such expansion produces the fissures in the bark, and, in the case of hardwoods and conifers, the expansion zone tissue is frequently cinnamon-colored and relatively soft. In smooth-barked trees (e.g., beech), injections can be made into lenticels (pores), or through the bark at any point.

In the case of woody plants that do not possess a ringlike cambium layer around the stem, e.g., monocotyledonous plants, e.g., palm trees, the fluid is injected into the interior of the stem at any depth.

The medicament to be injected is in fluid form. “Fluid”, as used herein, means a liquid substance to be injected into a plant. The fluid can be aqueous or oleaginous, and can contain dissolved materials, e.g., medicaments, e.g., chemicals for treating a disease, infestation, or other undesirable condition in the plant, or nutrients for maintaining or improving the health of the plant. The fluid can also be a suspension of such materials. The fluid can also be a gel (e.g., treatment with nematodes which are parasitic on certain pests are suspended in a gel for injection).

In one embodiment, the apparatus comprises a needle, a fluid reservoir which holds the fluid to be injected into the plant, and a carrier gas reservoir which holds a carrier gas. The carrier gas is used to propel the fluid through the needle and into the plant. The carrier can be any inert gas, i.e., a gas which does not react with the fluid or the medicaments dissolved or suspended in the fluid. Such gases can include, but are not limited to, carbon dioxide and nitrogen.

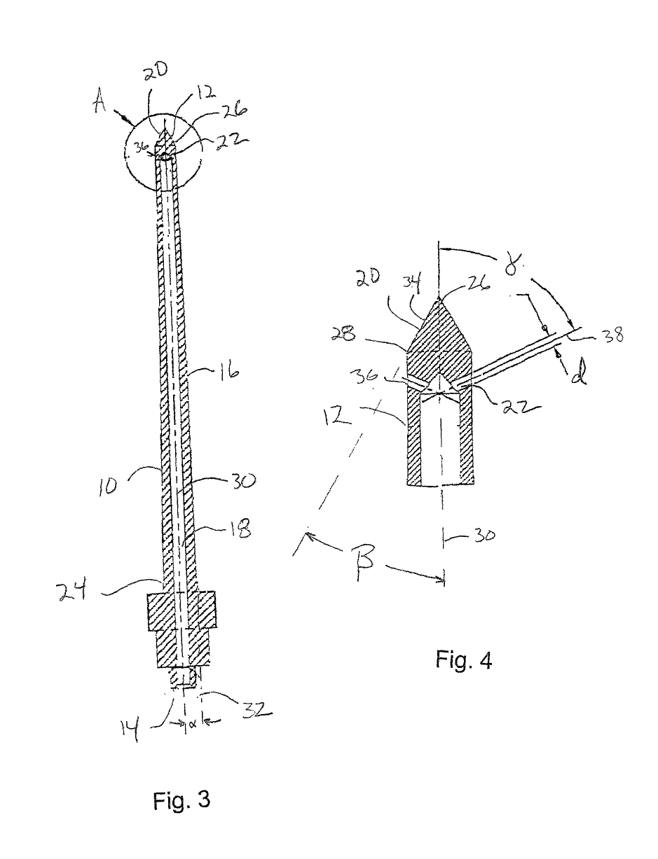

The needle 10 is shown in FIG. 3, and has a proximal end 14, a distal end 12, of which an enlarged detailed section A is shown in FIG. 4, an outer surface 16 and an inner conduit 18. The proximal end 14 is secured to the injector, not shown in FIG. 3. The distal end 12 has a sealed tip 20, and at least one aperture 22 connecting the inner conduit and the outer surface. The aperture 22 is proximate to the sealed tip 20. The apertures can have a diameter (d) in the range of between about 0.02 cm and about 0.1 cm. In one embodiment, the apertures are about 0.038 cm (0.015 inches) in diameter. In another embodiment, the apertures are about 0.081 cm (0.032 inches) in diameter.

In one embodiment, the needle shaft comprises two portions, a first portion 24 and a second portion 26. The first portion 24 extends from the proximal end 14 of the needle to a shoulder point 28, and the second portion 26 extends from the shoulder point 28 to the distal end 12.

The first portion 24 of the needle 10 can be straight or can have a first taper. All or a part of the first portion 24 can be tapered. The first taper is measured by the angle a between the longitudinal axis 30 of the needle 10 and the outer surface 16, as indicated by exterior line 32 of the first portion 24 of the needle. The first taper can have an angle of between 0° and about 5°. In one embodiment, the first taper is about 1°. In another embodiment, the first taper is about 1.5°.

It may be desirable for some uses to taper the first portion so as to increase the strength of the shaft while minimizing the width at the tip of the needle. The first taper can vary in relation to the overall length of the needle, allowing the means for attaching the needle to the injector to remain the same between different needles.

The second portion 26 has a second taper. The second taper is measured by the angle β between the longitudinal axis 30 of the needle 10 and the majority 34 of the outer surface of the second portion of the needle. The second taper can have angle β in the range of between about 10 degrees and about 50 degrees relative to the longitudinal axis of the needle. In another embodiment, the second taper can be about 20 degrees to about 40 degrees relative to the longitudinal axis of the needle. In one embodiment, the second taper is 30 degrees relative to the longitudinal axis of the needle.

Shoulder point 28 is the location on outer surface 16 of needle 10 at which the first portion 24 and the second portion 26 meet. The shoulder point 28 can be a discrete location, i.e., the change from the first taper to the second taper can be quite abrupt, or the shoulder point can be more diffuse and extend over a short distance, i.e., the shoulder point can exist as a curve describing a more gradual change between the first taper and the second taper.

The needle 10 has at least one aperture 22 connecting the inner conduit 18 of the needle 10 with the outer surface 16 of the needle 10. The location at which the aperture meets the outer surface is proximate to the distal end 12, and the sealed tip 20, of the needle 10. In one embodiment, the location at which the aperture 22 meets the outer surface 16 is proximate to the shoulder point 28. Placing the aperture 22 in this location, behind the shoulder point, reduces the incidence of plant debris breaking free from the plant and clogging the aperture 22.

In the case of a needle with more than one aperture, the apertures 22, 36 can be located on opposite sides of the needle for simpler and cheaper manufacture of the needle. The apertures can be located near each other for increased release of fluid in one direction within the tree (e.g., up, down).

The aperture or apertures connecting the inner conduit and the outer surface can be at an angle relative to the longitudinal axis 30 of the needle, and centerline 38 of the aperture 22. The apertures can be at angle γ relative to the longitudinal axis of the needle, provided that they are placed so that the majority of the fluid can be released into the desired location within the plant. The aperture can be at angle γ in the range of between about 50° and about 130°, or in another embodiment, about 60° and about 120°. In one embodiment, shown in FIG. 4, aperture is at angle γ of about 65°, relative to the longitudinal axis of the needle.

Depending on the plant structure and composition of the plant being injected, a needle with a relatively blunt tip, e.g., a second taper angle (β) of 50°, may not move deeply enough into the plant to inject the fluid at the desired location within the plant, without application of considerable force to the apparatus during placement of the needle within the plant. In such a case, it would be beneficial to manufacture the apertures with a relatively small forward angle (γ), e.g., 30° relative to the longitudinal axis of the needle. In another embodiment, a needle with a relatively sharp tip, e.g., a second taper angle (β) of 15° relative to the longitudinal axis of the needle, may move too deeply into the plant, also failing to inject the fluid at the desired location within the plant. In such a case, it would be beneficial to manufacture the apertures with an angle (γ) closer to 90° relative to the tip, or possibly even backward-facing (greater than 90°), depending on how deeply the needle tended to penetrate the plant during placement of the needle within the plant. If the needle is manufactured with a second taper such that the tip of the needle tends to penetrate the plant too deeply, then backward-facing apertures might be needed to place the fluid at the desired location within the plant. In one embodiment, e.g., with second taper angle (β) of 30°, the aperture has an angle of 65° relative to the longitudinal axis of the needle.

In another embodiment, the angle of the apertures relative to the longitudinal axis of the needle can be unchanged, and instead, the apertures can be placed either more proximally or more distally along the length of the needle.

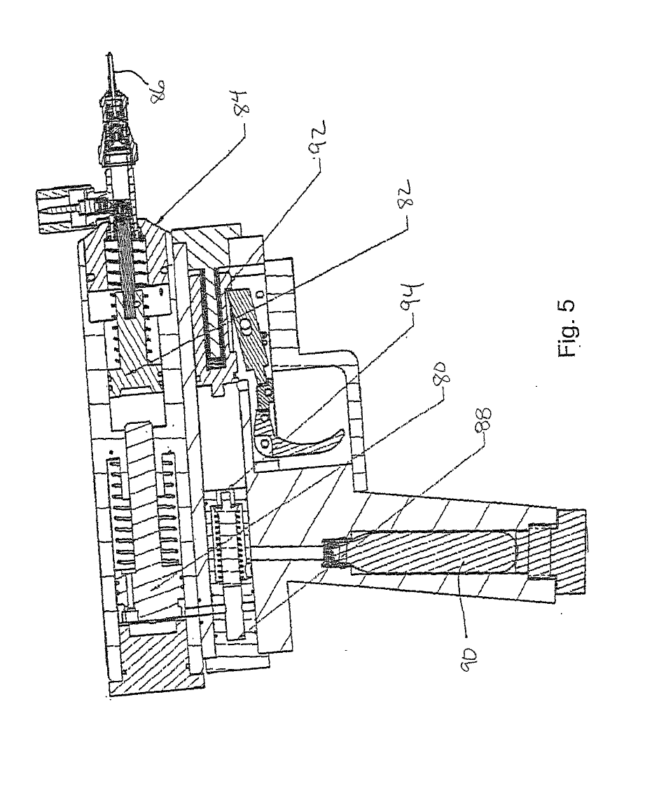

In one embodiment, shown in FIG. 5, the device employs a striking hammer anvil arrangement. The power piston 80 has the ability to gain inertia prior to contacting the work piston 82 connected to the inoculation head. The further away one places the inoculation head mounting plug 84 from the power piston, the smaller the shot size and the faster the power piston is moving prior to impact with the work piston creating a higher pressure at the needle 86. By increasing or decreasing the pressure screw 88, the charge pressure of carbon dioxide or other suitable gas from tank 90 can be varied to limit the working pressure available after the power piston and work piston make contact. The pressure screw is an additional needle pressure adjustment. The trigger piston 92 eliminates the ability of the operator to maintain gas pressure on the power piston after the trigger is pulled as the trigger piston is reset back to a “ready to fire” position by the gas dispensing valve 94 after each contact. Unless the operator releases the trigger, the trip is not reset and the trigger does not actuate the trigger piston release. The device can be fitted with a safety button that must be pushed to allow the trigger to be pulled. The device also can be cocked by hand to allow additional inoculations after the gas supply has been changed.

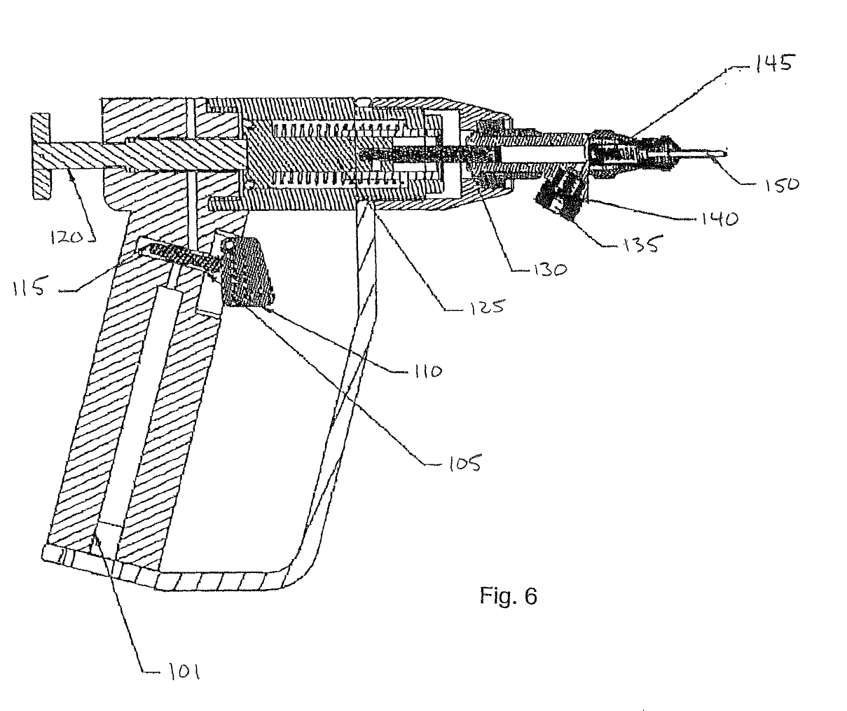

In another embodiment, shown in FIG. 6, the carrier gas is introduced into the HPA inlet port 101, shuttled into the power piston 125 via the shuttle valve 115 by depressing the trigger 110. The shot size is set by the shot size adjustment knob 120, which limits the return travel of the power piston 125. Once the power piston 125 is actuated, it pushes the injector rod 130, closing the inlet check valve 140 and opening the outlet check valve 145 at a set pressure that is adjustable via spring selection. When the trigger 110 is released, the shuttle valve 115 closes to HPA and opens to the HPA exhaust position 105 and the power piston 125 is allowed to return to the shot start set point. This draws back the injector rod 130, closing the outlet check valve 145 and opening the inlet check valve 140 to receive whatever positive pressure fluid is available at inlet port 135. As the pressure created by the outlet check valve 145 spring is still collapsing in the injection needle 150, there is no fluid “suck back”.

Several advantages provided by this embodiment include that it can operate at 70 kilopascals (10 pounds per square inch) to 4,138 kiloPascals (600 pounds per square inch); the shot size is set on the return stroke of the power piston, thereby reducing wear on the power portion of the device; there are four main sections which are replacable in the field; and can be easily disassembled for cleaning and repair.

In another embodiment, a suitable injection device is a Med-E-Jet D injection gun, available from Hypodermic Jet Injectors, 8092 Olmway Ave, Olmsted Falls, Ohio 44138. This injection device is a carbon dioxide, nitrogen air, or other generally inert gas injection tool using about 2,068 kilopascals (30° pounds per square inch) of pressure per injection. Each pull of the trigger administers from 0.05 to 1 milliliter of fluid. Incremental measurement can vary by calibration of 0.05 milliliter at a time. The mechanical device can derive its power from many different size CO₂ cartridges or tanks as well as from compressed air. The fluid to be injected is dispensed through the injection device from potentially many different size bottles or containers. A fifty milliliter removable bottle or container is in one embodiment.

Other examples of a suitable inoculator device are disclosed in U.S. Pat. Nos. 3,292,621 and 3,292,622, both of which were issued to Banker on Dec. 20, 1966. The teachings of both patents are incorporated herein by reference in their entirety.

In another embodiment, a suitable injection device is constructed partly or wholly from parts from paintball guns.

In another embodiment, the inoculator device is designed so as to minimize the resemblance to a gun.

By saying that the tip of the needle “terminates in a point” means that the tip is sharp or narrowly rounded, allowing relatively easy insertion through the bark and into the plant stem. In plants with very soft xylem, it is beneficial for the tip to be less sharp and more blunt, so that the needle does not sink into the tree such that the apertures are placed beyond the cambium.

The apparatus is placed with the needle resting against the plant. The operator applies force to the apparatus, pushing the distal end of the needle into the plant. In the case of plants with secondary growth, i.e., plants with xylem tissue, the operator pushes the apparatus and the needle into the plant until resistance is met. It is at this point that the tip of the needle is resting against the xylem, and the aperture(s) are located in the cambium. In the case of plants without secondary growth, e.g., palm trees, the apparatus and the needle are pushed into the interior of the stem of the plant.

Once the tip of the needle is placed at a satisfactory location for injection, the apparatus is triggered, and at least a portion of the fluid from the fluid reservoir is pushed with at least a portion of the carrier gas from the carrier gas reservoir, into the proximal end of the needle, through the inner conduit of the needle, and out of at least one of the aperture(s), and into the plant.

The dosage of medicament is based upon the absorption capability of the xylem (sapwood), or in the case of monocots, e.g., palms, the internal stem. Generally, 0.05 to 0.1 milliliters are injected at each site. For some plants, the dosage per injection can be about 0.25-0.30 milliliters. Examples of such trees are catalpa trees, tulip trees, willow trees and poplar trees. The injection site should be in healthy live tissue, equally placed around the circumference of the root, root flare, trunk, leader or branch. The plant is typically injected at 0.25-1.0 milliliters at a time with five to ten injections per 2.54 cm (1 inch) of diameter of the tree trunk. For instance, dicot and gymnosperm trees can be injected at 0.25 ml -0.50 ml per injection site, while monocots (e.g., palms) can be injected at 0.50 ml -1.0 ml per injection site. Dosage per plant can vary, e.g., from 1.0 ml to 10 ml per 2.54 cm (1 inch) diameter. Dosage will ultimately be determined by the medicament manufacturer's instructions, unless it can be determined that the dosage can be increased without harming the plant.

The injections should be at least 2.54 cm (1 inch) apart and done in a horizontal or vertical manner. On a 76 cm (30 inch) diameter tree, about 250 injections can be done about the circumference of the tree. Preferential uptake frequently occurs on tissues exposed to sunlight (e.g., warm, sunny side of a tree trunk). A warm water diluent in the injection site can follow the injections.

After treatment, the plant should be watered thoroughly, e.g., 2.54 cm (1 inch) of irrigation in the root zone, to ensure distribution of the medicamtn throughout the plant.

The amount of medicament injected can vary based upon the type of product used, the desired effect, or the temperature. Excess product can be washed off with water, if desired. Less than 2.54 cm (1 inch) diameter twigs are not recommended for injection, with the exception of vines and small saplings. The injection application can be made in any weather and at any time of year except in below freezing temperatures.

It is recommended that injection be avoided during time of leaf expansion, and leaf fall (if any).

When treating plants for pests, one should have knowledge of the life cycle of the pest. Treatment of plants with the invention affects pest control in 30 days, therefore, a 30-day or greater window should be scheduled for optimum control. For instance, elm trees can be treated for dutch elm disease four weeks before elm bark beetle flight and associated attack by beetles on trees.

The invention can also be used prophylactically. For instance, mineral supplements can be applied to prevent vascular wilt diseases (e.g., by injection of 10 ml mineral supplement per 2.54 cm (1 inch) stem diameter). In plants susceptible to early spring infections, treatment can be applied the previous autumn, e.g., copper/zinc chelate can be applied to sycamore trees in autumn to prevent sycamore anthracnose.

Because the medicaments are often toxic or hazardous chemicals, they should be handled according to the manufacturer's instructions and recommendations, e.g., stored in its original sealed container in a cool, dry place; stored in a manner as to prevent cross contamination with other pesticides, fertilizers or food; empty product containers should not be reused; used containers should be wrapped and placed in the trash, etc. When performing the injection method of the invention, protective eye wear and/or face gear and protective clothing, including rubber or neoprene gloves, should be worn. The apparatus and related equipment should always be cleaned and oiled after daily usage.

Examples of suitable injection compositions include fungicides, pesticides, growth regulators, nutrients and fertilizers, antibiotics, and botanical and herbal compositions.

Fungicides can include for example, but are not limited to, copper chelate, which is used to treat ash yellows, Dutch elm disease and fruit tree-related fungus problems; mefenoxam ((R)-2[(2.6-dimethylphenyl)-methoxyacetylamino]-propionic acid methyl ester), which is used to treat certain diseases in conifers, nonbearing citrus, nonbearing deciduous fruits and nuts, ornamentals and shade trees; propiconazole, which is used to treat broad spectrum systemic disease control for evergreens, ornamentals and shade trees; and others. For instance, 14.3% propaconazole can be applied at a rate of 10 ml per 2.54 cm (1 inch) diameter to control dutch elm disease in elm, and oak wilt in oak.

Pesticides can include for example, but are not limited to, abamectin B1, which is used for insect pest control for woody trees and shrubs for beetles, lace bugs, spider mites and leaf miners; imidacloprid, which is used for broad spectrum control for adelgid, armored scales, Asian longhorned beetle, aphids, elm leaf beetles, black vine weevil larvae, eucalyptus longhorned borer, flatheaded borers (including bronze birch borer and alder-birch borer), Japanese beetles, lace bugs, leaf hoppers, leaf miners, mealy bugs, sawfly larvae, pine tip moth larvae, psyllids, royal palm bugs, scale insects, thrips (suppression) and whiteflies; azadirachtin, which is used for insect pest control for aphids, armyworms, bagworms, beetles, grubs and weevils, cankerworms, caterpillars, loopers and moths, chafers, cutworms, flies, greenhouse leaf tiers, leaf hoppers, leaf miners, leaf rollers, leaf perforators, marsh crane flies, mealy bugs, psyllids, sawflies, thrips and whiteflies; nicotine sulfate, which is used for control of mites. For instance, 10% imidacloprid can be applied at a rate of 2 ml per 2.54 cm (1 inch) diameter to hemlock trees for control of wooly adelgid.

Growth Regulators can include for example, but are not limited to, potassium salts of 6-hydroxy-3-(2H)-pyridazinone, which is used as a growth inhibitor and retardants for shade trees, evergreens and ornamentals, and ethylene, which is a plant auxin used to inhibit seed set in invasive trees and to inhibit undesirable fruit set.

Nutrients and fertilizers can include for example, but are not limited to, 18-3-4 spring/fall fertilizer (e.g., “Dean's Green”, Blackstone Ag Inc., Mesa, Ariz., USA); 5-10-5 summer/winter fertilizer (e.g., “Nutra-green”, Blackstone Ag Inc., Mesa, Ariz., USA), fulvic acid (e.g., “LM-32”, Blackstone Ag Inc., Mesa, Ariz., USA), 14-2-3 fertilizer (e.g., “Enhance”, Blackstone Ag Inc., Mesa, Ariz., USA), chelates, including calcium nitrate, calcium, magnesium, phosphorus, potassium, sulfur, boron, cobalt, copper, iron, manganese, molybdenum, zinc, etc., and combinations thereof.

Antibiotics include, but are not limited to, oxytetracycline and/or streptomycin, which can be used to treat lethal yellows in palm and fire blight in apples.

Other suitable injection compositions include botanical and herbal products, e.g., organic plant extracts specifically formulated to increase natural plant defense mechanisms, to be used as prophylaxis or deterrents to infestation and/or infection by pests. Such compositions include, but are not limited to, extracts of Allium (e.g., A. cepa (onion) and/or A. sativum (garlic); as prophylaxis, to enhance plant defenses against infection, as natural sufonated compounds reduce susceptibility to infection), Capsicum (C. annuum (hot pepper); as prohylaxis, as such extracts reduce plant desirability as a food source), and Lycopersicon (L. esculentum (tomato); enhances plant resistance to infestation). Other compositions include biocontrols, e.g., injection of predatory nematodes into cavities, to control plant borers, e.g., red palm weevil, Asian long homed beetle, etc.

One of ordinary skill in the art can prepare and apply such products in concentrations and amounts according to the manufacturer's instructions. Alternatively, because the invention reduces release of the medicaments into the environment outside the plant (e.g., in soil and on leaves), one can use such products at concentrations greater than those recommended by the manufacturers, so long as the plant being treated is not injured by the higher concentrations. The method and apparatus of the invention are therefore especially useful in environmentally sensitive areas, where application to soil or foliage may result in leaching or drift onto other plants or into other areas. The present invention is also useful in locations or in situations where opportunities for traditional methods of treatment (e.g., foliar or soil application) are limited, e.g., where location of nearby structures or the height of the plant itself limit foliar or root application.

The invention can also be used to kill plants by application of poison, e.g., to kill invasive species in locations where machanical culling is not possible (e.g., in remote or inaccessible areas) or ineffective (e.g., in plants that produce new shoots from stumps or roots).

In another embodiment, the apparatus includes a variable velocity approach inverse to the size of dosage, producing an increase in available pressure delivered to the needle to deliver a 0.25 to 0.33 ml shot size through a larger orificed needle necessary to penetrate into the tree.

The device is an easily serviced product with interchangeable parts and extends the M.T.B.F. to greater than 250,000 shots. The mechanism is capable of withstanding a wide range of environments and skill levels of operators.

The device delivers a 0.25 ml to 1 ml dosage per shot through a needle with two, three or four opposing holes at an increased velocity capable of producing a spray, rather than a stream.

### EXAMPLE 1

### Injection of Large Diameter Dicot and Gymnnosperm Trees with Deep Fissures

To treat a tree having bark with deep fissures, e.g., elm, a needle 4 cm (1.75 inches) long with two apertures of 0.081 cm (0.032 inches) is used. To treat for Dutch Elm Disease, the trees are treated ˜6 weeks before the first flight of the elm bark beetle is predicted to occur. A solution of 14.3% propaconazole is prepared, and loaded into the injector. The needle and the propellant container are attached to the injector, and the injector is set so that which each trigger pull, 0.25 ml-0.50 ml of the propaconazole solution is released from the needle.

The needle is then inserted into a bark fissure until resistance is felt. The injection device is then triggered, releasing the propaconazole solution into the tree.

The injections are repeated as necessary. Propaconazole is generally applied at a rate of 10 ml per 2.54 cm diameter. An elm tree that is 28 cm (11 inches) in diameter will therefore require a total of 110 ml of solution, spread over the circumference of the tree. Such a volume can be introduced into the tree by 440 injections of 0.25 ml each, or by 220 injections of 0.50 ml each. The injection sites should be chosen, if possible, so that they are 2-3 cm (1 inch) apart. In order to spread out the injection sites, sites can be chosen up and down the tree.

### EXAMPLE 2

### Injection of Dicot and Gymnosperm Trees with Small Diameters and/or Smooth Bark

To treat a tree having smooth bark, or a young tree that has not yet developed deep fissures, a needle 2 cm (0.75 inches) long with two apertures of 0.038 cm (0.015 inches) is used. To treat young elm trees that have not yet developed fissures prophylactically for Dutch Elm Disease, the trees are treated ˜6 weeks before the first flight of the elm bark beetle is predicted to occur. A solution of 14.3% propaconazole is prepared, and loaded into the injector. The needle and the propellant container are attached to the injector, and the injector is set so that which each trigger pull, 0.25 ml 0.50 ml of the propaconazole solution is released from the needle.

The needle is then inserted into the bark until resistance is felt. The injection device is then triggered, releasing the propaconazole solution into the tree.

The injections are repeated as necessary. Propaconazole is generally applied at a rate of 10 ml per 2.54 cm diameter. An elm tree that is 8 cm (˜3 inches) in diameter will therefore require a total of 30 ml of solution, spread over the circumference of the tree. Such a volume can be introduced into the tree by 120 injections of 0.25 ml each, or by 60 injections of 0.50 ml each. The injection sites should be chosen, if possible, so that they are 2-3 cm (1 inch) apart. In order to spread out the injection sites, sites can be chosen up and down the tree.

### EXAMPLE 3

### Injection of Monocot Stem Tissue

The red palm weevil (Rhynchophorous ferrugineus) can be effectively treated in its early instar stages, which occurs in January, April and October in the Middle East. Dates are harvested from October through December.

Imidacloprid is effective against 5 day and 30-day larvae at rates of 1 gram per liter of diet. Weevils can be treated effectively with 10% imidacloprid applied to date palms at a rate of 6.25 ml per 2.54 cm (1 inch) diameter circumferentially around the plant stem with a needle 4 cm (1.75 inches) long with two apertures of 0.081 cm (0.032 inches).

Application between January 1 and April 30 allows a six-month window between treatment time and date harvest.

### EXAMPLE 4

### Injection of Vines

To treat grapevines, a needle 0.625 cm (0.25 inches) long with two apertures of 0.038 cm (0.015 inches) is used. To treat for Pearce's Disease, mineral supplementation therapy is used. A 100% solution of MinBoost (Blackstone Ag Inc., Mesa, Ariz., USA) is prepared, and loaded into the injector. The needle and the propellant container are attached to the injector, and the injector is set so that with each trigger pull, 0.25 ml of the solution is released from the needle.

The needle is then inserted into the bark until resistance is felt. The injection device is then triggered, releasing the solution into the vine stem.

The injections are repeated as necessary. The MinBoost is generally applied at a rate of 1.0 ml per 2.54 cm (1 inch) diameter. A grapevine that is 2.54 cm (1 inch) in diameter will therefore require a total of 1.0 ml of solution, spread over the circumference of the vine stem. Such a volume can be introduced into the vine by 4 injections of 0.25 ml each. The injection sites should be chosen, if possible, so that they are 2-3 cm (1 inch) apart. In order to spread out the injection sites, sites can be chosen up and down the vine stem.

### EXAMPLE 5

### Use of Botanical Formulations against Red Palm Weevil

Research has shown that glycoalkaloids, which are found in solanaceous plants, are effective against coleopteran insects. Such glycoalkaloids include α-solanine and α-tomatine, which are found in the leafy tissue of potatoes and tomatoes, respectively.

Glycoalkaloids can be toxic to humans. A 70 kg (150 pound) adult is affected by ingestion of glycoalkaloids in the range of 245 mg (the level at which toxic symptoms develop) to 315 mg (the level at which fatality occurs). The average potato contains about 7.5 mg glycoalkaloids per 100 g. A potato containing 14 mg/100 g tissue is bitter in taste. The average consumption of glycoalkaloids from eating potatoes is about 12.5 mg per person per day, which is about 10% of a lethal dose, and is found in about 1.7 potatoes. Glycoalkaloids are poorly absorbed in the intestinal tract.

Tomato leaves contain high levels of glycoalkaloids, e.g., ingestion of 56 g (2 ounces) of tomato leaves is considered deadly for an adult, and contains about 315 mg of tomatine.

Date palms come into production in their sixth year, when they are 180 cm (6 feet) high, and 30 cm (12 inches) in diameter. A date palm trunk therefore contains 127 liters of volume, and being 60% water, contains about 76 liters of water. To achieve an internal concentration of glycoalkaloids effective to kill red palm weevil larvae requires injection of 2,270 mg total glycoalkaloids.

Because date palm is a monocot, and internal fluid transport is in the vertical direction only (there are no horizontal fluid transport vessels), injections must be made around the complete circumference of the stem to ensure that the medicament is transported vertically to all areas of the palm tree. Failure to inject the entire circumference will result in treatment of only one side of the tree, from roots to shoots.

For therapy to be effective, the meristem (the location of development of new tissues) must be protected by treatment. In the palm, the meristem is located internally, about 45 cm (18 inches) below the tip of the date palm stem. The medicaments are therefore injected into this area. In a 180 cm (6 foot) date palm, this area is about 135 cm (54 inches) above the ground.

The teachings of all publications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for injecting a fluid into a woody plant, the method comprising:
(a) providing:
(i) a fluid reservoir containing a fluid;
(ii) a carrier gas reservoir containing a carrier gas;
(iii) a needle having a proximal end and a distal end, comprising:
(1) an inner conduit;
(2) a sealed tip terminating in a point at the distal end;
(3) an outer surface; and
(4) at least one aperture connecting the inner conduit and the outer surface and proximate to the point at said distal end; and
(iv) an injector connecting the fluid reservoir and the carrier gas reservoir to the proximal end of the needle, wherein the injector can direct at least a portion of the fluid from the fluid reservoir with at least a portion of the carrier gas from the carrier gas reservoir, through the inner conduit of the needle and out of at least one of the apertures;
(b) inserting the needle into the woody plant; and
(c) injecting, via the injector, at least a portion of the fluid from the fluid reservoir with at least a portion of the carrier gas from the carrier gas reservoir, through the inner conduit of the needle and out of at least one of the apertures and into the woody plant; thereby injecting the fluid into the woody plant.

2. The method of claim 1, wherein the woody plant is a tree.

3. The method of claim 1, wherein the woody plant is a palm tree.

4. The method of claim 1, wherein the method is repeated one or more times on the same woody plant.

5. The method of claim 1, wherein the fluid is a treatment for a disease condition.

6. The method of claim 1, wherein the fluid is a treatment for an insect infestation.

7. The method of claim 1, wherein the fluid is a nutrient.

8. The method of claim 1, wherein the fluid is a suspension.

9. The method of claim 1, wherein the needle is inserted into expansion tissue.

10. The method of claim 1, wherein the needle includes two apertures.

11. The method of claim 1, wherein the one or more apertures connecting the inner conduit and the outer surface are at a forward angle relative to the longitudinal axis of the needle.

12. The method of claim 11, wherein the one or more apertures are at an angle of about 50° to about 130° relative to the longitudinal axis of the needle.

13. The method of claim 12, wherein the one or more apertures are at an angle of about 60° to about 120° relative to the longitudinal axis of the needle.

14. The method of claim 12, wherein the one or more apertures are at an angle of about 65° relative to the longitudinal axis of the needle.

15. The method of claim 1, wherein at least a portion of the outer surface of the needle between the point and one of the apertures includes a taper.

16. The method of claim 15, wherein the needle has a first portion from the proximal end to a shoulder point, wherein said outer surface of said first portion has a first taper, and a second portion from the shoulder point to the distal end, wherein said second portion has a second taper which is substantially greater than the first taper.

17. The method of claim 16, wherein the second taper has an angle of about 10° to about 50° relative to the longitudinal axis of the needle.

18. A method for injecting a medicament into a plant comprising:
(a) providing a medicament for a plant;
(b) mixing said medicament with a compressed carrier gas; and
(c) directing said medicament and compressed carrier gas through the surface of a plant to inject said medicament into the plant.

19. The method of claim 18 wherein said medicament is selected from the group consisting of: a fertilizer, a pesticide, a fungicide, a growth regulator and a hormone.

20. The method of claim 18 wherein said carrier gas is selected from the group consisting of: carbon dioxide, air, nitrogen.

21. An apparatus for injecting a fluid into a woody plant, the apparatus comprising:
(a) a fluid reservoir containing a fluid;
(b) a carrier gas reservoir containing a carrier gas;
(c) a needle having a proximal end and a distal end, comprising:
(i) an inner conduit;
(ii) a sealed tip terminating in a point at the distal end;
(iii) an outer surface; and
(iv) at least one aperture connecting the inner conduit and the outer surface and proximate to the point at said distal end; and
(c) an injector connecting the fluid reservoir and the carrier gas reservoir to the proximal end of the needle, wherein the injector can direct at least a portion of the fluid from the fluid reservoir with at least a portion of the carrier gas from the carrier gas reservoir, through the inner conduit of the needle and out of at least one of the apertures.

22. The apparatus of claim 21, wherein the woody plant is a tree.

23. The apparatus of claim 21, wherein the woody plant is a palm tree.

24. The apparatus of claim 21, wherein the fluid is a treatment for a disease condition.

25. The apparatus of claim 21, wherein the fluid is a treatment for an insect infestation.

26. The apparatus of claim 21, wherein the fluid is a nutrient.

27. The apparatus of claim 21, wherein the fluid is a suspension.

28. The apparatus of claim 21, wherein the needle includes two apertures.

29. The apparatus of claim 21, wherein the one or more apertures connecting the inner conduit and the outer surface are at a forward angle relative to the longitudinal axis of the needle.

30. The apparatus of claim 29, wherein the one or more apertures are at an angle of about 50° to about 130° relative to the longitudinal axis of the needle.

31. The apparatus of claim 33, wherein the needle has a first portion from the proximal end to a shoulder point, wherein said outer surface of said first portion has a first taper, and a second portion from the shoulder point to the distal end, wherein said second portion has a second taper which is substantially greater than the first taper.

32. The apparatus of claim 31, wherein the second taper has an angle of about 10° to about 50° relative to the longitudinal axis of the needle.

33. The apparatus of claim 31, wherein at least one of the apertures is located between the shoulder point and the proximal end.
